(19) United States
(12) Patent Application Publication
(10) Pub. No.: US 2018/0150622 A1
(43) Pub. Date: May 31, 2018

(54) AUTHENTICATION SESSION MANAGEMENT

(71) Applicant: Lenovo (Singapore) Pte. Ltd., Singapore (SG)

(72) Inventors: Grigori Zaitsev, Durham, NC (US); Igor Stolbikov, Apex, NC (US); Timothy Winthrop Kingsbury, Cary, NC (US); Rod D. Waltermann, Rougemont, NC (US)

(21) Appl. No.: 15/362,060

(22) Filed: Nov. 28, 2016

(51) Int. Cl. G06F 21/32; G06K 9/00

(52) U.S. Cl. CPC G06F 21/32; G06K 9/00288; G06K 9/00228

(57) ABSTRACT

One embodiment provides a method, including: performing, at an electronic device, an initial authentication of a user using a first mechanism; entering, using a processor, an authentication session responsive to a successful result of the initial authentication of the user; thereafter detecting, using the processor, presence of the user by a second mechanism; and maintaining, using the processor, the authentication session in response to detecting the presence of the user. Other aspects are described and claimed.

### BACKGROUND

Electronic devices such as desktop computers, laptop computers, etc., are secured using a variety of techniques. For example, an alphanumeric password input via a keyboard is often required to gain access to a personal computer. There have been many developments in further increasing the security of such devices.

One example of device security is the use of a continuous authentication session in which a user is continuously (repeatedly) authenticated, with access to the device or certain device resources (applications, functions, data, etc.) conditioned on successfully maintaining the continuous authentication session. By way of specific example, a camera may be used to authenticate a user biometrically, e.g., using image data to match a pattern of user features to a known pattern of features, with the user required to continually face the camera and be re-authenticated according to a policy to maintain the continuous session.

### BRIEF SUMMARY

In summary, one aspect provides a method, comprising: performing, at an electronic device, an initial authentication of a user using a first mechanism; entering, using a processor, an authentication session responsive to a successful result of the initial authentication of the user; thereafter detecting, using the processor, presence of the user by a second mechanism; and maintaining, using the processor, the authentication session in response to detecting the presence of the user.

Another aspect provides an electronic device, comprising: an input device; a processor operatively coupled to the input device; and a memory storing code executable by the processor to: perform an initial authentication of a user using a first mechanism; enter an authentication session responsive to a successful result of the initial authentication of the user; thereafter detect presence of the user by a second mechanism; and maintain the authentication session in response to detecting the presence of the user.

A further aspect provides a program product, comprising: a non-transitory computer readable medium storing code that is executable by a processor, the code comprising: code that performs, at an electronic device, an initial authentication of a user using a first mechanism; code that enters an authentication session responsive to a successful result of the initial authentication of the user; code that thereafter detects presence of the user by a second mechanism; and code that maintains the authentication session in response to detecting the presence of the user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of maintaining an authentication session with user presence data.

FIG. 4 illustrates an example system for maintaining an authentication session with user presence data.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

While multiple continuous authentication solutions exist, these tend to employ a type of continuous authentication mechanism, e.g., use of continuous facial recognition, which are processor and power intensive. Further, when a user looks away (or otherwise the continuous facial recognition data is removed), the session ends. This may result in prematurely terminating the continuous authentication session, e.g., when the user simply looks away or is out of view of the camera, but has not actually left the device.

Accordingly, an embodiment provides for authentication sessions that are first initiated using a highly secure mechanism, e.g., alphanumeric password entry, facial recognition or other biometric authentication such as use of fingerprint data, etc., and thereafter may be maintained, conditioned on lower quality (less precise) user presence data being provided. This improves existing systems in that the processing, component, and/or power requirements are lessened, while security is maintained.

In an embodiment, a user may be periodically or intermittently required to re-authenticate using higher quality authentication data, e.g., alphanumeric password entry, providing facial recognition data and/or other biometric authentication data, etc., in order to maintain the continuous authentication session. For example, if a user's presence is lost, a re-authentication may be required. Further, if a highly secure system is desirable, timing or other policies may be implemented such that a user is required to re-authenticate using the initial mechanism or another mechanism after a predetermined or dynamically determined amount of time, on access attempt to certain system resources, etc. If a continuous authentication session is interrupted or ends, the user's access to the system or a sub-set of the system's resources may be reduced or terminated.

The illustrated example embodiments will be best understood by reference to the figures. The following description is intended only by way of example, and simply illustrates certain example embodiments.

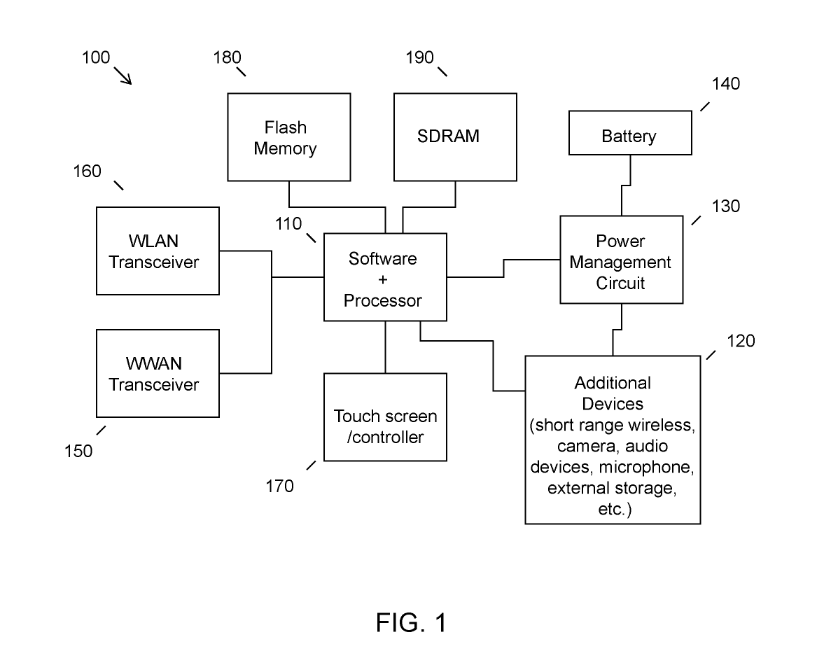

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery or battery pack 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., a wireless communication device, camera, external storage, etc. System 100 often includes a touch screen 170 for data input and display/rendering. System 100 also typically includes various memory devices, for example flash memory 180 and SDRAM 190.

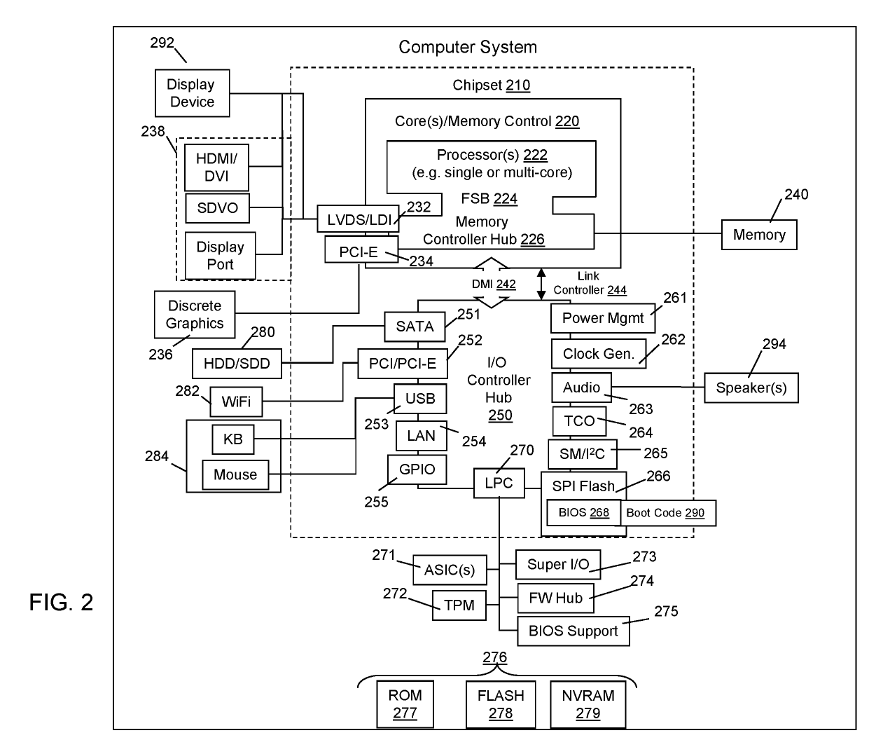

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as desktop computers, laptop computers, personal computer devices generally, and/or electronic devices that operate using a continuous authentication session in which a user's access to the system and/or system resources is conditioned on successfully maintaining the continuous authentication session via input of authentication data on an ongoing basis.

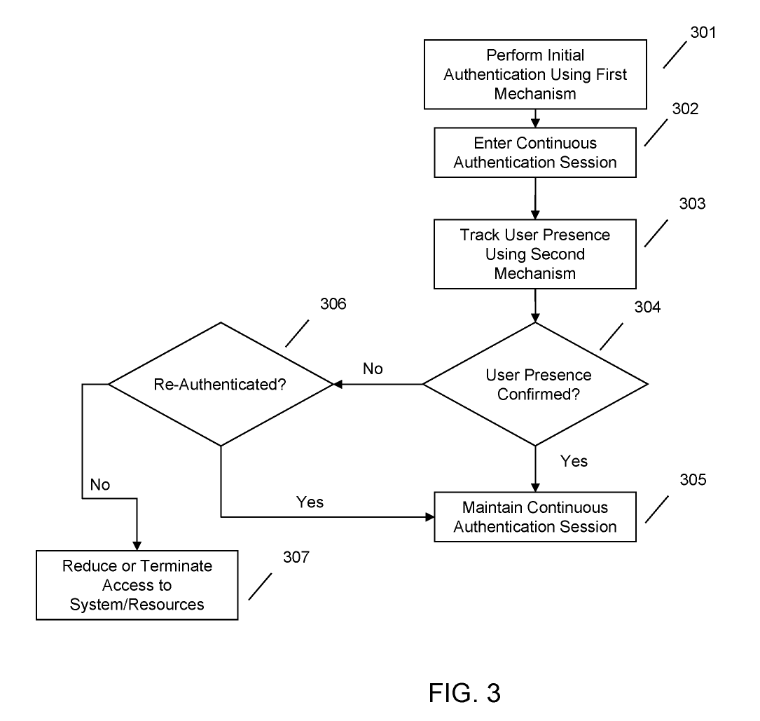

Referring now to FIG. 3, an example method of maintaining a continuous authentication session is illustrated. As shown, a first or initial authentication is performed at 301, e.g., a user is authenticated using a one or multi-factor authentication mechanism such as entry of an alphanumeric password, provision of fingerprint data to a fingerprint reader, provision of image data to a facial recognition sub-system, etc. This allows the system (e.g., desktop computer) to authenticate the user affirmatively and enter into a continuous authentication session at 302. The initial authentication at 301 is performed using a highly secure, first mechanism.

The system thereafter enters a tracking or maintenance mode at 303 in which user presence data is collected using a second mechanism in order to maintain the continuous authentication session. In an embodiment, the user presence data is used to confirm, at 304, that the user is still present following the user's secure authentication performed at 301. If so, the continuous authentication session can be maintained, as illustrated at 305. If the user presence cannot be confirmed, the user may be re-authenticated at 306 and the continuous session maintained at 305. Otherwise, i.e., if the user presence cannot be confirmed and/or the user is not re-authenticated, the system may log the user off or reduce the user's access to the system as illustrated at 307.

An embodiment employs user presence data for use in the second mechanism to relax the requirement of re-authenticating the user and wasting system resources such as processing power or power consumption generally required by a highly secure, first mechanism. Use of a second mechanism allows an embodiment to accurately track the user's continued presence following secure authentication, even if the user presence data is insufficient to authenticate the user.

By way of example, the second mechanism may comprise use of the same hardware component (e.g., a camera), but use of different data and/or analytics to confirm the user's presence rather than authenticate the user. Thus, if the first mechanism comprises authenticating the user by matching facial attributes in a facial recognition process, the second mechanism may track the user's presence by tracking the user's head, the color of the user's clothing, the general outline of a human form in the image, etc. Thus, although the user presence data is of lower quality and would not be reliable to authenticate the user (and thus distinguish a particular user from another), the user presence data is adequate for tracking a user's continued presence at or in the vicinity of the system, ensuring the initial, authenticated user, is in control of system security.

In another embodiment, different hardware components may be involved in the implementation of the first mechanism and the second mechanism. By way of example, the first mechanism may authenticate a user at 301 using alphanumeric password entry on a keyboard or a touch screen, and thereafter maintain the authentication session by tracking the user by way of audio data, e.g., collected through a microphone of the system. In this example, the second mechanism may simply distinguish human audio input from background noise in order to maintain the continuous authentication session, i.e., an audio input of a particular user is not required.

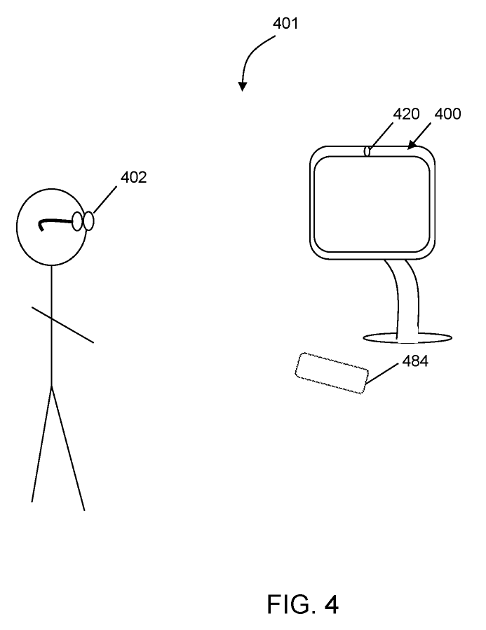

As a further example, and referring to FIG. 4, more than one device may be involved in maintaining the continuous authentication session. By way of example, a wearable device 402 may be used to implement the first and/or the second mechanism. Specifically, a wearable device 402, here illustrated as smart glasses, may collect image data to initially authenticate the user, e.g., via retinal authentication, and thereafter collect other data, e.g., proximity data collected through one or more contact sensors (not explicitly illustrated in FIG. 4), to confirm the user's presence generally. Data collected from the wearable device 402 may be provided to the main system 400 using a variety of communication techniques, e.g., wireless communication between the wearable device 402 and the main system 400.

Alternatively, a first user device, e.g., a keyboard 484, may be used to initially authenticate the user, and another device, e.g., a wearable device 402 that detects proximity or contact, may thereafter be used to provide the main system 400 with presence data required to maintain the continuous authentication session.

As with the initial authentication data, the presence data may take a variety of forms. For example, the presence data may be influenced by device capabilities, which may in turn influence management of the continuous authentication session. As a specific example, if the wearable device 402 is a smart watch, pulse data may be collected as user presence data to confirm the user's presence and thus to maintain an initiated continuous authentication session. Depending on the quality of the pulse data, e.g., its ability to inform the system of the user's heart rate, etc., the continuous authentication session may require less re-authentication of the user, e.g., by use of alphanumeric password entry or higher security authentication techniques. In contrast, if the user presence data is low quality (in terms of distinguishing one user from the next, e.g., simple contact data), the continuous authentication session may increase the number of times the user is asked to re-authenticate using a more secure mechanism.

It is noted herein that although examples have been provided in connection with personal computing devices, various embodiments may be implemented in different contexts. For example, an automobile's on-board computer may be configured to require continuous authentication, using presence data as described herein to maintain the session. In such a case, a user may be required to provide adequate presence data to maintain access to different system resources, e.g., ability to drive the car, ability to operate the car above a certain speed, ability to access electronic features, etc. As with the other examples, the quality of the presence data and/or the sensitivity of the resource being protected with the continuous authentication may dictate certain parameters or characteristics of the continuous authentication session, e.g., how often re-authentication is required, what type of data is required to maintain the continuous authentication session, etc.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
performing, at an electronic device, an initial authentication of a user using a first mechanism;
entering, using a processor, an authentication session responsive to a successful result of the initial authentication of the user;
thereafter detecting, using the processor, presence of the user by a second mechanism; and
maintaining, using the processor, the authentication session in response to detecting the presence of the user.

2. The method of claim 1, wherein the first mechanism is selected from the group consisting of password authentication and biometric authentication.

3. The method of claim 2, wherein the second mechanism is a tracking mechanism.

4. The method of claim 3, wherein the tracking mechanism comprises obtaining tracking data of at least one user characteristic.

5. The method of claim 4, wherein the at least one user characteristic is selected from the group consisting of clothing color, hair color, body outline, and voice characteristic.

6. The method of claim 3, wherein the tracking mechanism comprises receiving presence data from a wearable device associated with the user.

7. The method of claim 1, wherein the first mechanism and the second mechanism are implemented using different hardware components.

8. The method of claim 7, wherein the first mechanism is implemented using at least a camera and wherein the second mechanism is implemented using at least a microphone.

9. The method of claim 1, further comprising:
responsive to not detecting the presence of the user by the second mechanism, re-authenticating the user using the first mechanism; and
thereafter maintaining the authentication session in response to re-authenticating the user using the first mechanism.

10. The method of claim 1, wherein the authentication session is ended in response to not detecting the presence of the user by the second mechanism.

11. The method of claim 1, wherein the authentication session comprises a continuous authentication session.

12. An electronic device, comprising:
an input device;
a processor operatively coupled to the input device; and
a memory storing code executable by the processor to:
perform an initial authentication of a user using a first mechanism;
enter an authentication session responsive to a successful result of the initial authentication of the user;
thereafter detect presence of the user by a second mechanism; and
maintain the authentication session in response to detecting the presence of the user.

13. The electronic device of claim 12, wherein the first mechanism is selected from the group consisting of password authentication and biometric authentication.

14. The electronic device of claim 13, wherein the second mechanism is a tracking mechanism.

15. The electronic device of claim 14, wherein the tracking mechanism comprises obtaining tracking data of at least one user characteristic.

16. The electronic device of claim 15, wherein the at least one user characteristic is selected from the group consisting of clothing color, hair color, body outline, and voice characteristic.

17. The electronic device of claim 14, wherein the tracking mechanism comprises receiving presence data from a wearable device associated with the user.

18. The electronic device of claim 12, wherein the first mechanism and the second mechanism are implemented using different hardware components.

19. The electronic device of claim 18, further comprising a camera and a microphone, wherein the first mechanism is implemented using at least the camera and wherein the second mechanism is implemented using at least the microphone.

20. The electronic device of claim 11, wherein the code is executed by the processor to:
responsive to not detecting the presence of the user by the second mechanism, re-authenticate the user using the first mechanism; and
thereafter maintain the authentication session in response to re-authenticating the user using the first mechanism.

21. The method of claim 12, wherein the authentication session comprises a continuous authentication session.

22. A program product, comprising:
a non-transitory computer readable medium storing code that is executable by a processor, the code comprising:
code that performs, at an electronic device, an initial authentication of a user using a first mechanism;
code that enters an authentication session responsive to a successful result of the initial authentication of the user;
code that thereafter detects presence of the user by a second mechanism; and
code that maintains the authentication session in response to detecting the presence of the user.
